(19) United States
(12) Patent Application Publication
(10) Pub. No.: US 2025/0111982 A1
(43) Pub. Date: Apr. 3, 2025

(54) COIL COMPONENT AND POWER SUPPLY APPARATUS

(71) Applicant: TDK CORPORATION, Tokyo (JP)

(72) Inventors: Katsushi YASUHARA, Tokyo (JP); Ryoma NAKAZAWA, Tokyo (JP); Yuji SEZAI, Tokyo (JP); Sena YOSHINO, Tokyo (JP)

(73) Assignee: TDK CORPORATION, Tokyo (JP)

(21) Appl. No.: 18/899,985

(22) Filed: Sep. 27, 2024

(30) Foreign Application Priority Data
Sep. 29, 2023 (JP) 2023-170019

(51) Int. Cl. H01F 27/255; H01F 27/28

(52) U.S. Cl. CPC H01F 27/255; H01F 27/28

(57) ABSTRACT

A coil component may include a core portion including a soft magnetic metal material and a winding portion including a conductor wound. The winding portion may be inside the core portion. The core portion may include a central portion and an outer portion. The central portion may be disposed in an inside diameter portion of the winding portion. The outer portion may be disposed in a portion other than the central portion. The central portion may include a first central portion and a second central portion including different materials. The second central portion may be disposed around the first central portion. H, S, and S₁ may be within specific ranges, where H denotes a height of the winding portion, S denotes a sectional area of the central portion, and S₁ denotes a sectional area of the first central portion.

The present application claims a priority to Japanese patent application No. 2023-170019 filed on Sep. 29, 2023, which is incorporated herein by reference in its entirety.

### BACKGROUND

The present disclosure relates to a coil component and a power supply apparatus.

Patent Document 1 discloses various magnetic devices including a T-shaped magnetic core.

Patent Document 2 discloses an inductance element in which a magnetic body having a relatively high permeability is disposed in an air core portion.
Patent Document 1: U.S. Pat. No. 9,959,965 Specification
Patent Document 2: JP Patent Application Laid Open No. 2003-168610

### SUMMARY

A coil component according to one aspect of the present disclosure is
a coil component including:
a core portion including a soft magnetic metal material; and
a winding portion including a conductor wound,
wherein
the winding portion is inside the core portion;
the core portion includes a central portion and an outer portion;
the central portion is disposed in an inside diameter portion of the winding portion;
the outer portion is disposed in a portion other than the central portion;
the central portion includes a first central portion and a second central portion including different materials;
the second central portion is disposed around the first central portion; and
X defined by a mathematical formula 1 satisfies 0.50 or more and 0.90 or less, the mathematical formula 1 being defined as follows:

$$X = \frac{\sqrt{π}}{2} \times \frac{H \times \sqrt{{S}_{1}}}{S}$$

where
H denotes a height of the winding portion in a section containing an axial centerline of the winding portion,
S denotes a sectional area of the central portion in a section perpendicular to the axial centerline of the winding portion, and
S₁ denotes a sectional area of the first central portion in the section perpendicular to the axial centerline of the winding portion.

A power supply apparatus according to one aspect of the present disclosure includes the above coil component.

### BRIEF DESCRIPTION OF THE DRAWING(S)

FIG. 1 is a sectional schematic view of an inductor according to one example aspect of the present disclosure.

FIG. 2 is a sectional schematic view along line I-I shown in FIG. 1.

FIG. 3 is a schematic view of a positional relationship between members, before thermocompression bonding, used in a process of manufacturing an inductor according to one example aspect of the present disclosure.

FIG. 4 is a schematic view of a positional relationship between members, before thermocompression bonding, used in a process of manufacturing an inductor according to one example aspect of the present disclosure.

FIG. 5 is a schematic view of a positional relationship between members, before thermocompression bonding, used in a process of manufacturing an inductor according to one example aspect of the present disclosure.

FIG. 6 is a schematic view of a positional relationship between members, before thermocompression bonding, used in a process of manufacturing an inductor of a comparative example.

### DETAILED DESCRIPTION

One embodiment of the present disclosure is described below with reference to the drawings. The following embodiment of the present disclosure is an exemplification illustrative of the present disclosure. Various elements, such as numerical values, shapes, materials, and manufacturing steps, according to the embodiment of the present disclosure can be modified or changed to the extent that technical problems do not arise.

Shapes and the like illustrated in the drawings of the present disclosure do not necessarily match actual shapes and the like, because the former may be modified for illustration purposes.

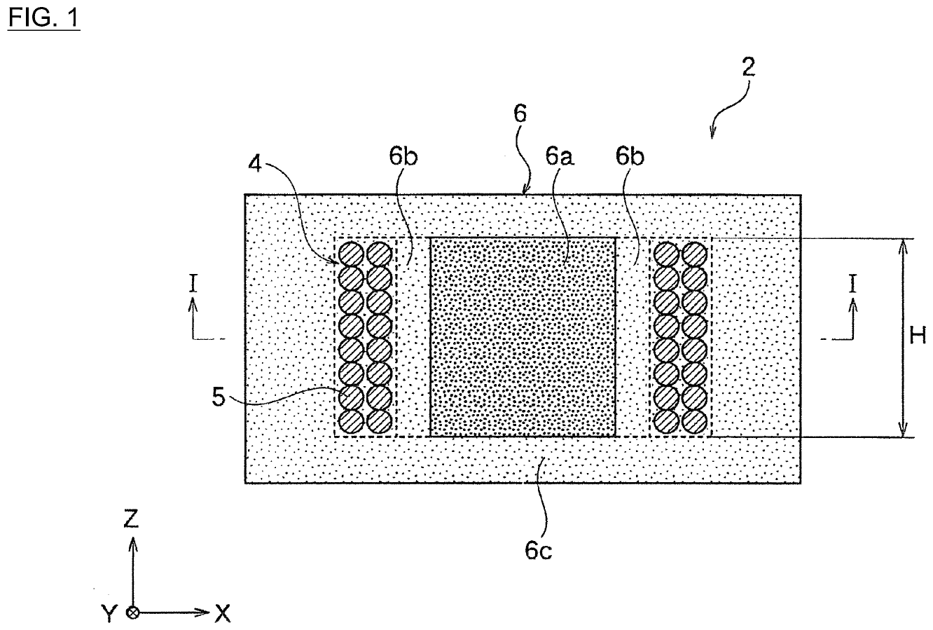

As shown in FIG. 1, an inductor 2, which is one type of a coil component according to one embodiment of the present disclosure, includes a winding portion 4 and a core portion 6. The winding portion 4 includes a conductor 5 wound in a coil shape. The core portion 6 includes a central portion, which is disposed in an inside diameter portion of the winding portion 4, and an outer portion, which is a portion other than the central portion.

An upper surface and a lower surface of the core portion 6 of the inductor 2 according to the one embodiment of the present disclosure are perpendicular to the Z-axis. Side surfaces of the core portion 6 are perpendicular to a plane containing the X-axis and the Y-axis. A winding axis of the winding portion 4 is parallel to the Z-axis. However, the core portion 6 may have any other shapes other than the shape shown in FIG. 1.

In the present disclosure, “parallel” denotes not only a complete parallel state but also a substantially parallel state. That is, in some embodiments of the present disclosure, “parallel” denotes a state with variation within manufacturing tolerance. In some embodiments of the present disclosure, “parallel” denotes a state with variation exceeding the manufacturing tolerance. Specifically, a line A being parallel to a line B denotes that an angle formed by the lines A and B is 0° or more and 10° or less unless otherwise specified. The same applies to a situation where either one of the lines is or both of the lines are replaced with a plane or planes.

In the present disclosure, “perpendicular” denotes not only a complete perpendicular state but also a substantially perpendicular state. That is, in some embodiments of the present disclosure, “perpendicular” denotes a state with variation within manufacturing tolerance. In some embodiments of the present disclosure, “perpendicular” denotes a state with variation exceeding the manufacturing tolerance. Specifically, a line A being perpendicular to a line B denotes that an angle formed by the lines A and B is 80° or more and 100° or less unless otherwise specified. The same applies to a situation where either one of the lines is or both of the lines are replaced with a plane or planes.

The inductor 2 according to the embodiment of the present disclosure may have any size. In some embodiments, the inductor 2 has a size of a rectangular parallelepiped having a bottom surface measuring 2 mm×2 mm and a height of 1 mm as lower size limits of portions other than portions not shown in the drawings (e.g., lead portions or terminals described later). In some embodiments, the inductor 2 has a size of a cube having a bottom surface measuring 25 mm×25 mm and a height of 25 mm as upper size limits of the portions other than the portions not shown in the drawings. The height denotes a length in the Z-axis direction in FIG. 1. In FIG. 1, illustration of the lead portions of the winding portion 4, the terminals, etc. is omitted. In some embodiments, the conductor constituting the winding portion 4 includes the lead portions at both ends. In some embodiments, the lead portions are drawn outside the core portion 6.

The conductor (conductive wire) 5 constituting the winding portion 4 is covered with, at its periphery, an insulating coating as necessary. The conductor 5 may be made from any material. In some embodiments, the conductor 5 is made from, for example, Cu, Al, Fe, Ag, Au, or an alloy containing some of these metals. The insulating coating may be made from any material. In some embodiments, examples of materials of the insulating coating include polyurethane, polyamide-imide, polyimide, polyester, polyester-imide, and/or polyester-nylon.

The conductor 5 may have any cross-sectional shape. Examples of cross-sectional shapes include a circular shape and a rectangular shape. In the embodiment of the present disclosure, the conductor 5 has a circular cross-sectional shape.

The core portion 6 includes at least a soft magnetic metal material. In some embodiments, the core portion 6 is, for example, a dust core including soft magnetic metal particles (one type of soft magnetic metal materials). In some embodiments, the core portion 6 is a sintered metal core including soft magnetic metal particles (one type of soft magnetic metal materials). In some embodiments, the core portion 6 is a core resulting from winding a soft magnetic metal ribbon (one type of soft magnetic metal materials). In some embodiments, the core portion 6 is a core resulting from laminating soft magnetic metal ribbons (one type of soft magnetic metal materials). The following description is provided on the premise that the core portion 6 includes soft magnetic metal particles as its soft magnetic metal material.

The soft magnetic metal particles may be made from any material. In some embodiments, examples of materials of the soft magnetic metal particles include ferrites (e.g., Mn—Zn ferrites and Ni—Cu—Zn ferrites) and soft magnetic alloys (e.g., Fe—Si alloys, Fe—Si—Al alloys, Fe—Si—Cr alloys, and permalloys (Fe—Ni alloys)). The soft magnetic metal particles may have any microstructure. In some embodiments, the microstructure of the soft magnetic metal particles is amorphous. In some embodiments, the microstructure of the soft magnetic metal particles includes crystals. In some embodiments, in a situation where the soft magnetic metal particles are amorphous, the soft magnetic metal particles are flattened in advance with a pulverizer or the like. In a situation where the soft magnetic metal particles include crystals, the crystals may have any crystal grain size. In some embodiments, the crystal grain size is, for example, 1 μm or less.

In some embodiments, the core portion 6 includes a thermosetting resin (binder). The thermosetting resin may be of any type. Examples of thermosetting resins include an epoxy resin, a diallyl phthalate resin, a phenol resin, polyimide, polyamide-imide, a silicone resin, and a combination of some of these.

The core portion 6 includes the central portion, which is disposed in the inside diameter portion of the winding portion 4; and the outer portion 6c, which is disposed in the portion other than the central portion. The central portion includes a first central portion 6a and a second central portion 6b disposed around the first central portion 6a. A space between the central portion (second central portion 6b) and the winding portion 4 is sufficiently small. The volume of this space is 5% or less out of the volume (100%) of the inside diameter portion of the winding portion 4.

The first central portion 6a and the second central portion 6b are made from different materials. In some embodiments, the first central portion 6a and the outer portion 6c are made from the same material. In some embodiments, the first central portion 6a and the outer portion 6c are made from different materials. In some embodiments, a part of the outer portion 6c and the first central portion 6a are made from the same material; and in some embodiments in which a part of the outer portion 6c and the first central portion 6a are made from the same material, this part of the outer portion 6c is particularly a part that overlaps a portion extending in the Z-axis direction and/or an opposite direction of the Z-axis direction from the first central portion 6a. In some embodiments, the second central portion 6b and the outer portion 6c are made from the same material. In some embodiments, the second central portion 6b and the outer portion 6c are made from different materials. In some embodiments, in a situation where the second central portion 6b and a large part of the outer portion 6c are made from different materials, a part of the outer portion 6c and the second central portion 6b are made from the same material. In some embodiments, in a situation where the second central portion 6b and the large part of the outer portion 6c are made from different materials, the outside of this large part of the outer portion 6c is particularly a part that overlaps a portion extending in the Z-axis direction and/or the opposite direction of the Z-axis direction from the second central portion 6b, and the outside of this large part of the outer portion 6c and the second central portion 6b are made from the same material. In some embodiments, a portion of the first central portion 6a and/or the second central portion 6b that is near the outer portion 6c in the Z-axis direction is made from the same material as the outer portion 6c.

In some embodiments, the first central portion 6a and the second central portion 6b are distinguished in, for example, observation of a section perpendicular to the winding axis direction of the winding portion 4 using a general-purpose image analysis apparatus (e.g., SEM). This is because there is a difference in contrast between the first central portion 6a and the second central portion 6b. The difference in contrast may be generated due to, for example, differences in particle size, material, average aspect ratio, average degree of orientation, and packing density of the soft magnetic metal particles included in the first and second central portions. The difference in contrast may also be generated due to, for example, differences in type or content of organic compounds (resin) or inorganic substances included in the first and second central portions. That is, between the first central portion 6a and the second central portion 6b is at least one difference selected from, for example, differences in material, average aspect ratio, average degree of orientation, or packing density of the soft magnetic metal particles included in the first and second central portions; differences in type or content of organic compounds or inorganic substances included in the first and second central portions; and differences in density between the first and second central portions.

In some embodiments, in particular, the first central portion 6a and the second central portion 6b have different magnetic permeabilities. In some embodiments, the first central portion 6a and the outer portion 6c have different permeabilities. In particular, in a situation where the first central portion 6a has a high permeability, DC superimposition characteristics of the inductor 2 are readily improved.

Typically, the lower the organic compound content (which may hereinafter be simply referred to as organic substance content) of the central portion, the higher the permeability of the central portion tends to be. In some embodiments, the first central portion 6a has an organic substance content lower than that of the second central portion 6b. In this situation, a material of the first central portion 6a readily has a permeability higher than that of a material of the second central portion 6b. In some embodiments, the organic substance content of the first central portion 6a is 1.5 wt % or less.

In some embodiments, at least a part of the core portion 6 substantially does not contain an organic compound. In some embodiments, the first central portion 6a substantially does not contain an organic compound. Note that “substantially does not contain an organic compound” denotes that the organic substance content is 0 wt % or more and 0.1 wt % or less.

In some embodiments, the first central portion 6a, the second central portion 6b, and/or the outer portion 6c are powder compacts (bodies) including the soft magnetic metal particles and the resin. That is, in some embodiments, in a situation where the second central portion 6b and a large part of the outer portion 6c are made from different materials, the core portion 6 includes powder compacts (bodies) including the soft magnetic metal particles and the resin.

Any method of measuring the organic substance content may be used. In some embodiments, for example, a thermogravimetry-differential thermal analysis (TG-DTA) is used. In some embodiments, loss on ignition measured using the TG-DTA method is deemed to be the organic substance content.

The first central portion 6a readily has a high permeability when the soft magnetic metal particles included in the first central portion 6a have a large average particle size. In some embodiments, the soft magnetic metal particles included in the first central portion 6a have an average particle size of 0.5 μm or more and 50 μm or less. In some embodiments, the soft magnetic metal particles included in the second central portion 6b have an average particle size of 0.1 μm or more and 40 μm or less. In some embodiments, the average particle size of the soft magnetic metal particles included in the first central portion 6a is larger than the average particle size of the soft magnetic metal particles included in the second central portion 6b. Specifically, the average particle size of the soft magnetic metal particles included in the first central portion 6a is larger by 105% or more than the average particle size of the soft magnetic metal particles included in the second central portion 6b.

In some embodiments, the soft magnetic metal particles included in the first central portion 6a have an average degree of orientation different from that of the soft magnetic metal particles included in the second central portion 6b with respect to the winding axis direction of the winding portion. The first central portion 6a readily has a high permeability when the soft magnetic metal particles included in the first central portion 6a have a high average degree of orientation with respect to the winding axis direction.

The first central portion 6a readily has a high permeability when the composition of the soft magnetic metal particles included in the first central portion 6a has an inevitable impurity content (e.g., phosphorus, carbon, or oxygen content) lower than that of the composition of the soft magnetic metal particles included in the second central portion 6b.

In some embodiments, the soft magnetic metal particles included in the first central portion 6a have a packing ratio higher than that of the soft magnetic metal particles included in the second central portion 6b. The higher the packing ratio of the soft magnetic metal particles included in the first central portion 6a, the higher the permeability of the first central portion 6a tends to be. In some embodiments, the packing ratio of the soft magnetic metal particles included in the first central portion 6a is 70% or more. In some embodiments, the packing ratio of the soft magnetic metal particles included in the first central portion 6a divided by the packing ratio of the soft magnetic metal particles included in the second central portion 6b is 1.03 or more. The packing ratio of the soft magnetic metal particles is defined as an area percentage of the soft magnetic metal particles calculated from a sectional SEM image of the first central portion 6a and the second central portion 6b.

In some embodiments, the first central portion 6a, the second central portion 6b, and/or the outer portion 6c are sintered bodies. In some embodiments, the sintered bodies are produced by sintering powder compacts (bodies). The sintered bodies are readily produced so that they substantially do not contain an organic compound.

The first central portion 6a, the second central portion 6b, and the outer portion 6c are each in a uniform state unless otherwise specified in the following description of the present disclosure.

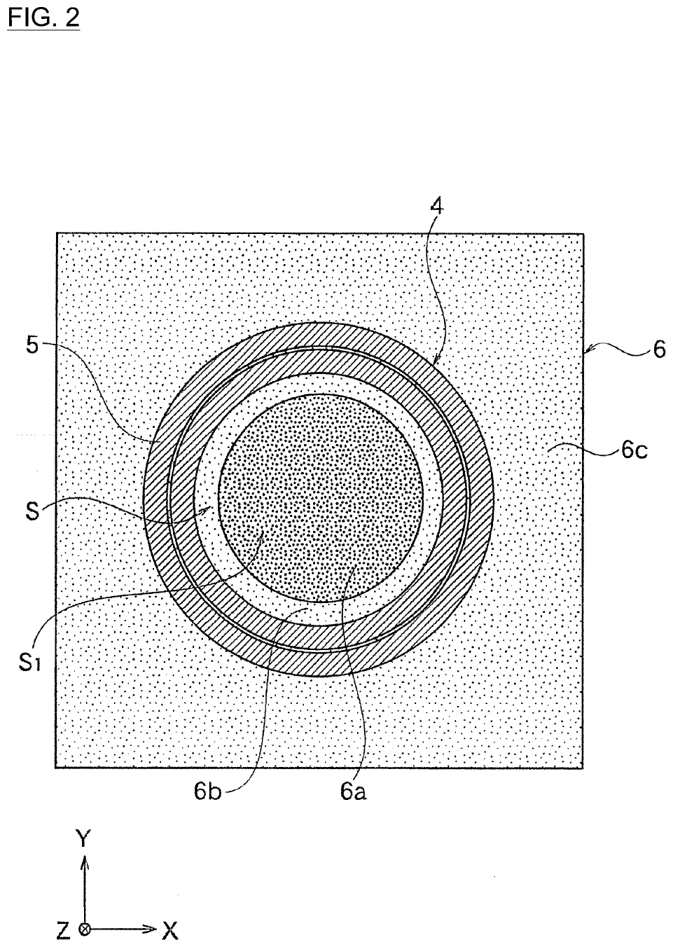

In some embodiments, the first central portion 6a has, for example, a cylindrical shape as shown in FIGS. 1 and 2. The shape of the first central portion 6a is not limited to the cylindrical shape. In some embodiments, the first central portion 6a has, for example, an elliptic cylinder shape or a quadrangular prism shape.

As shown in FIG. 1, H denotes the height of the winding portion 4 in a section containing an axial centerline of the winding portion 4. As shown in FIGS. 1 and 2, S denotes a sectional area of the central portion in a section perpendicular to the axial centerline of the winding portion 4, and Si denotes a sectional area of the first central portion 6a in the section. In this situation, X defined by the following formula satisfies 0.50 or more and 0.90 or less.

$$X = \frac{\sqrt{π}}{2} \times \frac{H \times \sqrt{{S}_{1}}}{S} \qquad [ Mathematical formula 1 ]$$

It has been assumed that, in a situation where a conventional central portion is made from one type of material and is uniform in its entirety, reducing a space between this central portion and a winding portion 4 as much as possible improves inductance and DC superimposition characteristics. Similarly, it has been assumed that, in a situation where this central portion includes a portion having a higher permeability than other portions, reducing the percentage of the other portions in this central portion as much as possible improves inductance and DC superimposition characteristics. The following description is provided on the premise that the space between the central portion (second central portion 6b) and the winding portion 4 is sufficiently small.

The present inventors have found that X and DC superimposition characteristics of the inductor 2 are correlated, where X denotes a product of a quotient of the inside diameter of the winding portion 4 (equivalent to an equivalent circle diameter of the central portion) divided by the height H of the winding portion 4 and a quotient of the diameter of the first central portion 6a (equivalent circle diameter of the first central portion 6a) divided by the inside diameter of the winding portion 4 (equivalent to the equivalent circle diameter of the central portion). The present inventors have consequently found that X being within a specific range improves DC superimposition characteristics of the inductor 2.

Specifically, X satisfying 0.50 or more and 0.90 or less improves DC superimposition characteristics of the inductor 2.

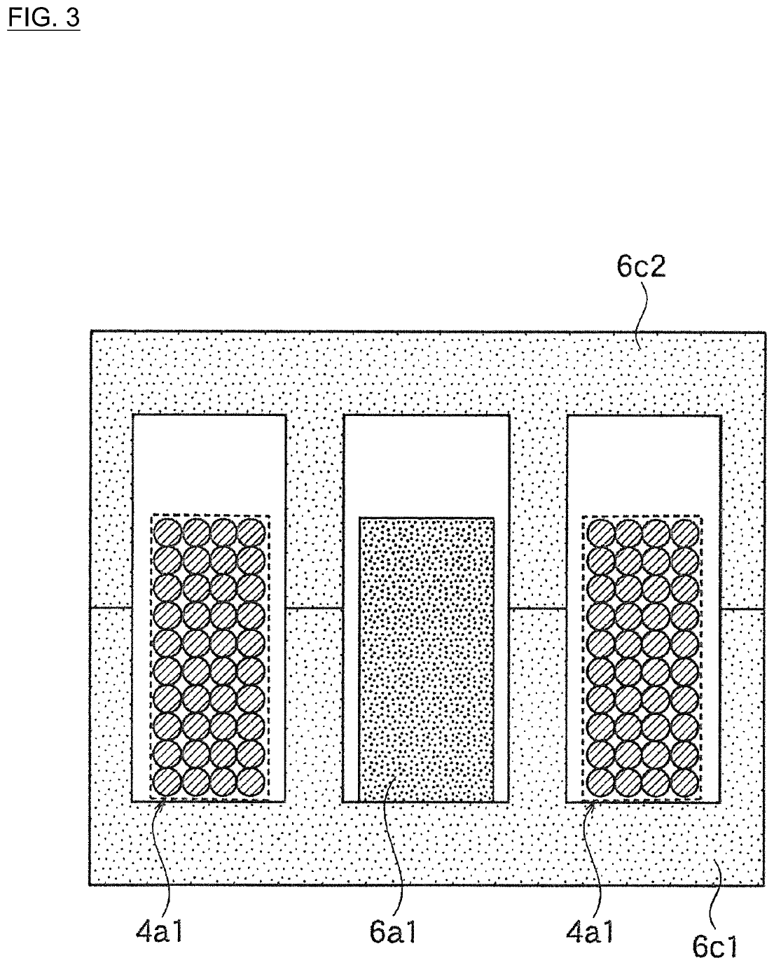

Methods of manufacturing the inductor 2 shown in FIG. 1 are described next with reference to FIGS. 3 to 5.

### (Manufacturing Method 1)

As shown in FIG. 3, the inductor 2 manufactured using a manufacturing method 1 of manufacturing the inductor 2 of the one embodiment of the present disclosure is manufactured by integrating a first central core 6a1, which eventually becomes mainly the first central portion 6a; a base core 6c1 and a cover core 6c2, which eventually become mainly the second central portion 6b and the outer portion 6c; and an insert member 4a1 including the winding portion 4 composed of an air core coil or the like. In some embodiments, a core material (not shown in the drawings), which eventually becomes mainly the second central portion 6b and/or the outer portion 6c, is used.

In FIG. 3, the length of the first central core 6a1 in the Z-axis direction and the length of the winding portion 4 in the Z-axis direction are the same. However, in some embodiments, the length of the first central core 6a1 in the Z-axis direction is longer than the length of the winding portion 4 in the Z-axis direction. In this situation, a protruding portion of the first central core 6a1, i.e., a portion of the first central core 6a1 around which the winding portion 4 is not disposed, is pushed by the cover core 6c2 at the time of thermocompression bonding described later and is deformed to move mainly to the first central portion 6a, which is filled with the protruding portion. In some embodiments, a portion of the outer portion 6c eventually overlapping a portion extending from the first central portion 6a in the Z-axis direction and/or the opposite direction of the Z-axis direction is filled with the protruding portion of the first central core 6a1. In this situation as well, DC superimposition characteristics of the inductor 2 improve.

### (First Central Core 6a1)

As materials of the first central core 6a1, a resin and a soft magnetic metal powder including soft magnetic metal particles are prepared (provided).

The soft magnetic metal particles included in the soft magnetic metal powder may have any shapes. In some embodiments, the soft magnetic metal particles have, for example, a spherical shape. In some embodiments, the soft magnetic metal particles have a flat shape. In some embodiments, the soft magnetic metal particles have a needle-like shape. The soft magnetic metal powder may have any average particle size. In some embodiments, the average particle size is, for example, 0.5 μm to 50 μm. In some embodiments, a soft magnetic metal powder resulting from mixing multiple types of soft magnetic metal particles having different shapes, different average particle sizes, or the like is prepared (provided).

The resin may be of any type. Examples of resins include an epoxy resin, a phenol resin, a polyimide resin, a polyamide-imide resin, and a silicone resin. In some embodiments, a resin in which some of these resins are appropriately combined is prepared (provided).

Next, the soft magnetic metal powder and the resin are mixed and are granulated into granules. Any method of granulation may be used. In some embodiments, for example, the resin is added to the soft magnetic metal powder, and the mixture is stirred and then dried. In some embodiments, an average size of the granules or granule size distribution is appropriately controlled.

The proportion of the resin is not limited. In some embodiments, the resin weighs, for example, 1.0 part by weight to 6.0 parts by weight with respect to 100 parts by weight of the soft magnetic metal powder.

In some embodiments, before the soft magnetic metal powder is mixed with the resin, an insulating film is provided on surfaces of the soft magnetic metal particles. In some embodiments, for example, a sol gel method is used to provide the insulating film, which is a SiO₂ film.

In some embodiments, after addition of the resin to the soft magnetic metal powder and stirring, the stirred mixture is sieved with a mesh to remove coarse granules. In some embodiments, the resin is diluted with a solvent when added to the soft magnetic metal powder. As the solvent, for example, ketone is used.

Next, compression molding is carried out to prepare the first central core 6a1. Specifically, a mold is filled with the resulting granules, and pressure is applied, to give the first central core 6a1. The first central core 6a1 prepared by compression molding is a powder compact (body) including the soft magnetic metal particles and the resin.

The pressure applied is not limited. The higher the pressure, the higher the packing ratio of the soft magnetic metal particles tends to be. In some embodiments, the pressure applied is, for example, 400 MPa to 1000 MPa.

In some embodiments, during molding of the first central core 6a1, pressure is applied while a magnetic field is applied. Controlling the direction in which the magnetic field is applied and/or the magnitude of the magnetic field may be able to change the degree of orientation of the soft magnetic metal particles.

Further, in some embodiments, the first central core 6a1 prepared by compression molding is sintered by firing. In some embodiments, for example, the firing time is 0.5 to 3 hours, and the firing temperature is 700° C. to 900° C. In some embodiments, the firing atmosphere is nitrogen. Sintering of the first central core 6a1 reduces the amount of an organic compound included in the first central core 6a1, eventually enabling the first central portion 6a to substantially not contain an organic compound.

### (Base Core 6c1)

The base core 6c1 having a shape shown in FIG. 3 is prepared. Any method of preparing the base core 6c1 may be used. In some embodiments, a method similar to the method of preparing the first central core 6a1 may be used. In some embodiments, a soft magnetic metal powder used in preparation of the base core 6c1 is of the same type as the soft magnetic metal powder used in preparation of the first central core 6a1. In some embodiments, the soft magnetic metal powder used in preparation of the base core 6c1 is different from the soft magnetic metal powder used in preparation of the first central core 6a1. In some embodiments, a resin used in preparation of the base core 6c1 is of the same type as the resin used in preparation of the first central core 6a1. In some embodiments, the resin used in preparation of the base core 6c1 is different from the resin used in preparation of the first central core 6a1.

### (Cover Core 6c2)

The cover core 6c2 having a shape shown in FIG. 3 is prepared. Any method of preparing the cover core 6c2 may be used. In some embodiments, a method similar to the method of preparing the first central core 6a1 may be used. In some embodiments, a soft magnetic metal powder used in preparation of the cover core 6c2 is of the same type as the soft magnetic metal powder used in preparation of the first central core 6a1. In some embodiments, the soft magnetic metal powder used in preparation of the cover core 6c2 is different from the soft magnetic metal powder used in preparation of the first central core 6a1. In some embodiments, a resin used in preparation of the cover core 6c2 is of the same type as the resin used in preparation of the first central core 6a1. In some embodiments, the resin used in preparation of the cover core 6c2 is different from the resin used in preparation of the first central core 6a1.

### (Core Material)

In a situation where the core material is used, the core material may be of any type. In some embodiments, the core material is, for example, a mixture of a resin and a soft magnetic metal powder including soft magnetic metal particles. In some embodiments, the soft magnetic metal powder used for the core material is of the same type as the soft magnetic metal powder used in preparation of the first central core. In some embodiments, the soft magnetic metal powder used for the core material is different from the soft magnetic metal powder used in preparation of the first central core. In some embodiments, the soft magnetic metal powder used for the core material is of the same type as the soft magnetic metal powder used in preparation of the base core. In some embodiments, the soft magnetic metal powder used for the core material is different from the soft magnetic metal powder used in preparation of the base core. In some embodiments, the soft magnetic metal powder used for the core material is of the same type as the soft magnetic metal powder used in preparation of the cover core. In some embodiments, the soft magnetic metal powder used for the core material is different from the soft magnetic metal powder used in preparation of the cover core. In some embodiments, the resin used for the core material is of the same type as the resin used in preparation of the first central core. In some embodiments, the resin used for the core material is different from the resin used in preparation of the first central core. In some embodiments, the resin used for the core material is of the same type as the resin used in preparation of the base core. In some embodiments, the resin used for the core material is different from the resin used in preparation of the base core. In some embodiments, the resin used for the core material is of the same type as the resin used in preparation of the cover core. In some embodiments, the resin used for the core material is different from the resin used in preparation of the cover core.

Further, the mixture of the resin and the soft magnetic metal powder including the soft magnetic metal particles may have any shape. In some embodiments, the mixture is, for example, granular. In some embodiments, the mixture is a paste. In some embodiments, in a situation where the paste is prepared, the mixture is heated as necessary.

### (Insert Member)

The insert member 4a1 including the winding portion 4 formed by winding the conductor in a coil is prepared. Both ends of the conductor constituting the winding portion 4 are drawn outside the winding portion 4 as lead-out wires. In some embodiments, terminals are connected to the lead-out wires after molding described later. In some embodiments, the terminals are connected to the lead-out wires in advance before molding described later. In some embodiments, joints between the terminals and the lead-out wires are located outside the outer portion 6c. In some embodiments, the joints between the terminals and the lead-out wires are located inside the outer portion 6c. The shape of the winding portion 4 is not limited to a circle viewed from its winding axis direction. In some embodiments, the shape of the winding portion 4 is elliptical, quadrilateral, or the like when viewed from its winding axis direction. In FIGS. 3 to 5, illustration of the lead-out wires and the terminals is omitted. As the number of turns in FIGS. 3 to 5 is different from that of FIGS. 1 and 2, in some embodiments, the number of turns is appropriately modified.

### (Integration of First Central Core, Base Core, Cover Core, and Insert Member)

First, the base core 6c1 is inserted into a mold. Then, as shown in FIG. 3, the insert member 4a1 and the first central core 6a1 are disposed at a predetermined location above the base core 6c1.

Then, the cover core 6c2 is inserted into the mold and is disposed at a predetermined location above the insert member 4a1, the first central core 6a1, and the base core 6c1 as shown in FIG. 3. In some embodiments, the mold is appropriately filled with the core material before the cover core 6c2 is inserted into the mold. The following description is provided on the premise that the mold is not filled with the core material before the cover core 6c2 is inserted into the mold.

Then, molding by thermocompression bonding is carried out. Specifically, after the cores inserted into the mold are heated to a temperature at which the resin softens, the base core 6c1, the first central core 6a1, the cover core 6c2, and the insert member 4a1 inserted into the mold are thermocompression-bonded. In some embodiments, the cores, the insert member, etc. are heated (preheated) in advance. In some embodiments, the frame, punch, or the like of the mold are heated. The direction in which pressure is applied is the winding axis direction of the coil. By pressing, the coil and the cores are thermocompression-bonded for integration. The cores are deformed by thermocompression bonding, and spaces shown in FIG. 3 are appropriately filled with the cores. The pressure of thermocompression bonding is not limited. The pressure is, for example, 100 MPa to 400 MPa. The temperature of thermocompression bonding is not limited. The temperature is, for example, 50° C. to 100° C.

By thermocompression bonding, the base core 6c1, the first central core 6a1, and the cover core 6c2 are integrated to give the core portion 6. That is, the core portion 6 including the first central portion 6a, the second central portion 6b, and the outer portion 6c is obtained.

In some embodiments, the inductor 2 taken out from the mold after thermocompression bonding is heated to further cure the resin. The heating temperature at this time is not limited. In some embodiments, the heating temperature is, for example, 150° C. to 200° C.

### (Manufacturing Method 2)

A manufacturing method 2 is described below. The manufacturing method 2 is similar to the manufacturing method 1 unless otherwise specified.

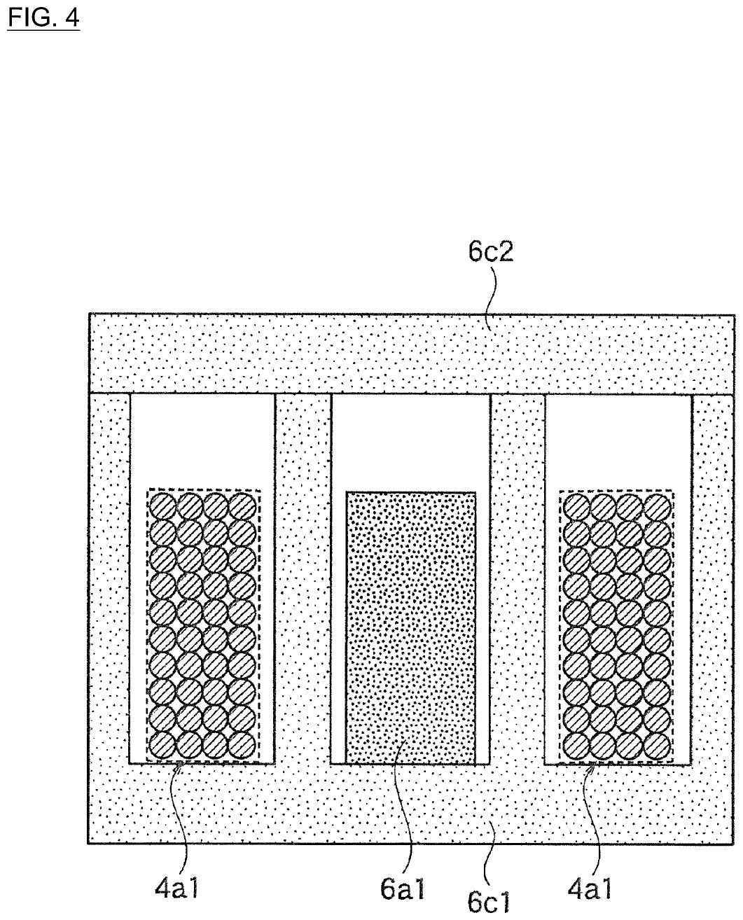

As shown in FIG. 4, the inductor 2 manufactured using the manufacturing method 2 of manufacturing the inductor 2 of the one embodiment of the present disclosure is manufactured by integrating a first central core 6a1, which eventually becomes mainly the first central portion 6a; a base core 6c1, which eventually becomes mainly the second central portion 6b and the outer portion 6c; a cover core 6c2, which eventually becomes mainly the outer portion 6c; and an insert member 4a1 including the winding portion 4 composed of an air core coil or the like.

In the manufacturing method 1 shown in FIG. 3, the base core 6c1 and the cover core 6c2 both have a shape similar to a pot-type shape. By contrast, in the manufacturing method 2 shown in FIG. 4, the base core 6c1 has a shape similar to a pot-type shape, and the cover core 6c2 has a shape similar to a flat plate shape.

### (Manufacturing Method 3)

A manufacturing method 3 is described below. The manufacturing method 3 is similar to the manufacturing method 2 unless otherwise specified.

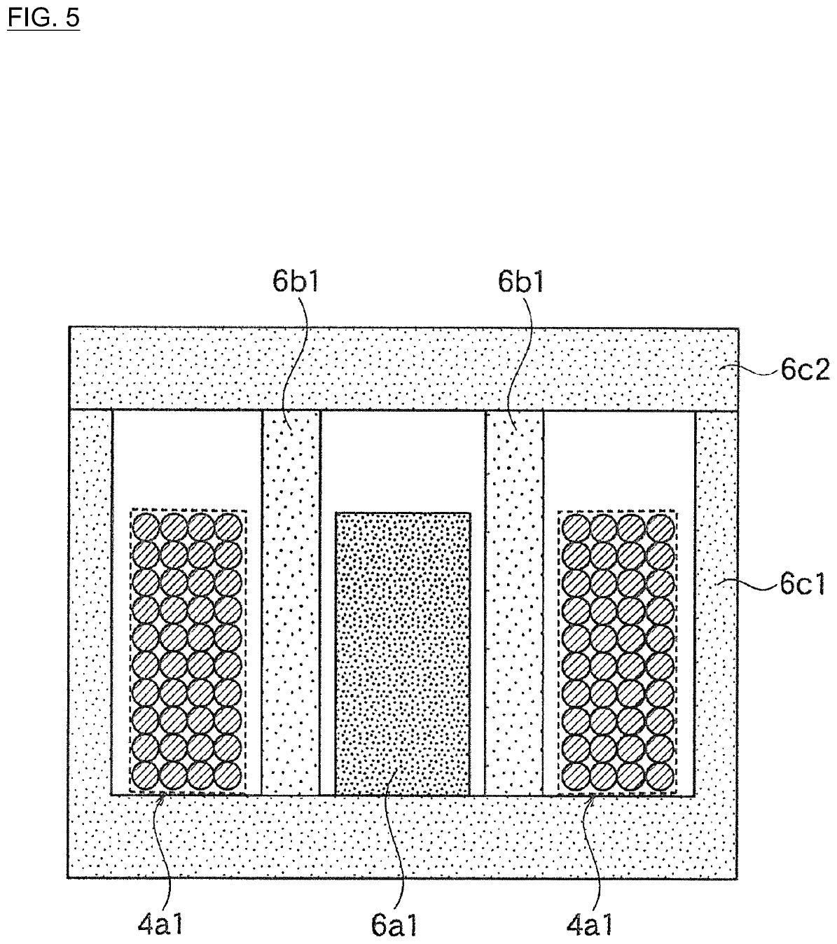

As shown in FIG. 5, the inductor 2 manufactured using the manufacturing method 3 of manufacturing the inductor 2 of the one embodiment of the present disclosure is manufactured by integrating a first central core 6a1, which eventually becomes mainly the first central portion 6a; a second central core 6b1, which eventually becomes mainly the second central portion 6b; a base core 6c1, which eventually becomes mainly the outer portion 6c; a cover core 6c2, which eventually becomes mainly the outer portion 6c; and an insert member 4a1 including the winding portion 4 composed of an air core coil or the like.

In the manufacturing method 2 shown in FIG. 4, the base core 6c1 has a shape similar to a pot-type shape. By contrast, in the manufacturing method 3 shown in FIG. 5, an inside tubular portion of the base core 6c1 of the manufacturing method 2 shown in FIG. 4 is separated as the second central core 6b1.

Using the manufacturing method 1 or 2, the inductor 2 in which the second central portion 6b and the outer portion 6c are made from the same material is readily manufactured. By contrast, using the manufacturing method 3, with the second central core 6b1 being made from a material different from that of other cores, the inductor 2 in which the second central portion 6b and the outer portion 6c are made from different materials is readily manufactured.

### (Other Manufacturing Methods)

Methods of manufacturing the inductor 2 according to the present disclosure are not limited to those described above. In particular, the shapes and the number of cores are not limited as long as the inductor 2 shown in FIG. 1 is eventually obtained. Also, in some embodiments, the inductor 2 is a magnetic substance molded coil component, i.e., a coil component entirely sealed in resin except for a lead portion of a wire, as described in the present disclosure.

Coil components according to the present disclosure are not limited to inductors. In some embodiments, the coil components are, for example, coil components such as transformers or reactors. However, a fact that the coil components according to the present disclosure readily have improved inductance and a fact that it is difficult for a transformer or a reactor to be integrally molded being considered, the coil components according to the present disclosure are inductors in some embodiments.

A power supply apparatus according to the present disclosure includes the above coil component. In some embodiments, the power supply apparatus is, for example, a power supply such as a DC-DC converter or a switching power supply.

### EXAMPLES

Hereinafter, the present disclosure is described based on further detailed examples. However, the present disclosure is not limited to these examples.

### Experiment 1

A method of manufacturing inductor samples of Examples and Comparative examples (excluding Sample No. 7) shown in Table 1 is described.

First, a first central core 6a1, a base core 6c1, and a cover core 6c2 having respective shapes shown in FIG. 3 were prepared. Further, an insert member 4a1 including a winding portion 4, lead-out wires, and terminals was prepared. Note that, in FIG. 3, illustration of the lead-out wires and the terminals is omitted.

### (First Central Core)

As materials of the first central core 6a1, a resin and a soft magnetic metal powder including soft magnetic metal particles were prepared. The soft magnetic metal particles were made from an Fe—Si alloy (Fe 95.5 wt %, Si 4.5 wt %). The soft magnetic metal powder had an average particle size of 25 μm. As the resin, an epoxy resin was used.

Then, an insulating film was provided on surfaces of the soft magnetic metal particles. Specifically, a sol gel method was used to provide the insulating film, which was a SiO₂ film. The insulating film had a thickness of about 40 nm.

Next, the soft magnetic metal powder and the resin were mixed and were granulated into granules. Specifically, the resin was added to the soft magnetic metal powder, and the mixture was stirred and then dried at 40° C. for 10 hours. The proportion of the resin was such that a first central portion 6a of each inductor sample eventually obtained had an organic substance content shown in Table 1. The type of the resin was the epoxy resin. After addition of the resin to the soft magnetic metal powder and stirring, the stirred mixture was sieved with a mesh to remove coarse granules. Specifically, the mixture was sieved with a mesh with an opening of 100 μm. Eventually resulting granules had an average size of about 60 μm.

Then, a mold was filled with the resulting granules for core molding to give the first central core 6a1 having a cylindrical shape. The first central core 6a1 had dimensions such that S₁ of the first central portion 6a of the inductor sample eventually obtained was as shown in Table 1, that all portions corresponding to the first central portion 6a had an organic substance content shown in Table 1, and that all portions corresponding to an outer portion 6c had an organic substance content shown in Table 1. The molding pressure was 600 MPa. The direction in which pressure was applied was parallel to a winding axis direction of the coil of the coil component eventually obtained.

### (Base Core and Cover Cover)

The base core 6c1 had a shape shown in FIG. 3, which was a shape of a second central portion 6b and the outer portion 6c of the inductor sample eventually obtained. A method of preparing the base core 6c1 was similar to the method of preparing the first central core 6a1 except for the following.

The proportion of a resin in the base core 6c1 was such that the second central portion 6b and the outer portion 6c of the inductor sample eventually obtained each had an organic substance content shown in Table 1. Soft magnetic metal particles used in preparation of the base core 6c1 were made from Fe 95.5 wt % and Si 4.5 wt %. The soft magnetic metal powder had an average particle size of about 25 μm. The molding pressure was about 600 MPa.

The cover core 6c2 had a shape shown in FIG. 3, which was a shape of the second central portion 6b and the outer portion 6c of the inductor sample eventually obtained. A method of preparing the cover core 6c2 was similar to the method of preparing the base core 6c1.

The material, average particle size, molding pressure, resin content, etc. of the base core 6c1 and the cover core 6c2 were controlled so that an inductance L0 before a direct current was applied was about 100 μH. Specifically, the resin content was changed from that of the method of preparing the first central core. Further, as necessary, the average particle size of the soft magnetic metal powder and/or the molding pressure or the like were slightly changed from those of the method of preparing the first central core.

### (Insert Member)

The winding portion 4 of the insert member 4a1 had an outside diameter of 4.67 mm, an inside diameter of 2.80 mm, a wire diameter (diameter of a conductor 5) of 0.22 mm, a number of turns N of 61.5 ts., and a height H of 4.16 mm. The conductor 5, the lead-out wires, and the terminals were made from Cu.

### (Integration of First Central Core, Base Core, Cover Core, and Insert Member)

First, the base core 6c1 was inserted into a mold. Then, as shown in FIG. 3, the insert member 4a1 and the first central core 6a1 were disposed at a predetermined location above the base core. Further, as shown in FIG. 3, the cover core 6c2 was disposed at a predetermined location.

Then, molding by thermocompression bonding was carried out. Specifically, after the base core 6c1, the first central core 6a1, the insert member 4a1, and the cover core 6c2 inserted into the mold were heated at 80° C. to soften the resin, pressure was applied to them. The direction in which pressure was applied was the winding axis direction of the coil. By pressing, the coil and the cores were thermocompression-bonded for integration. The molding pressure of thermocompression bonding was controlled within 100 MPa to 300 MPa so that the inductance L0 before a direct current was applied was about 100 μH.

The inductor 2 taken out from the mold after molding by thermocompression bonding was heated to cure the resin. The heating temperature was 150° C. to 200° C. The heating time was 1 hour to 3 hours.

The above steps gave the inductor 2 shown in FIG. 1. The outer portion 6c of the inductor 2 had a dimension of 5.50 mm×5.50 mm×5.15 mm (height).

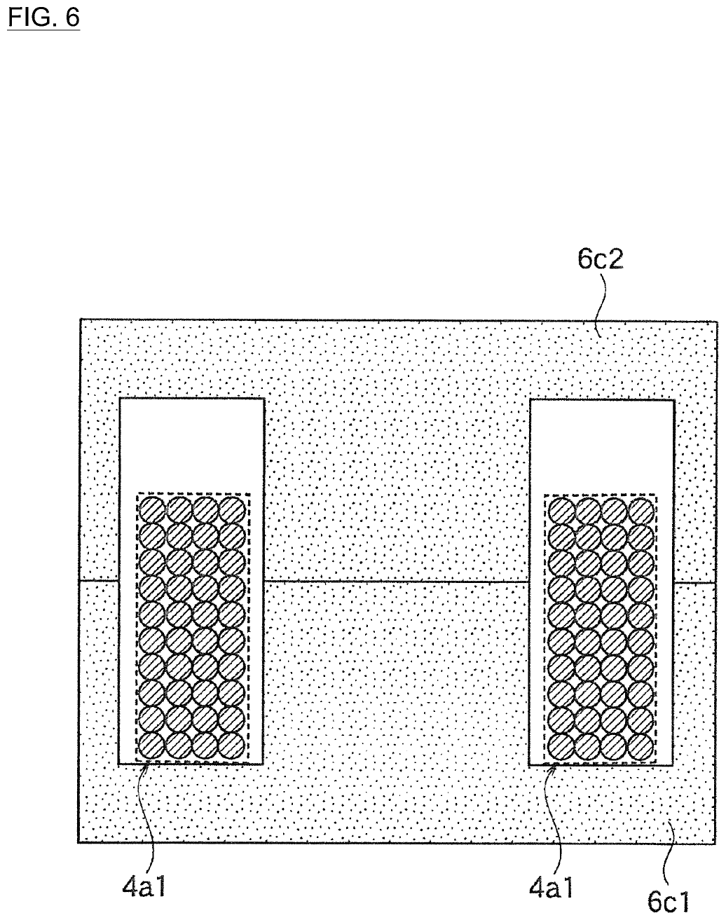

Sample No. 7 (Comparative example) shown in Table 1 was carried out as in Sample Nos. 1 to 6 except that no first central core 6a1 was used and that a base core 6c1 and a cover core 6c2 having respective shapes shown in FIG. 6 were used.

In all Examples (excluding those in which the first central core was sintered as described later) of Experiments 1 to 5, the soft magnetic metal particles of the first central portion, the soft magnetic metal particles of the second central portion, and the soft magnetic metal particles of the outer portion had a packing ratio of 69% and an average degree of orientation of 0.0.

The packing ratio of the soft magnetic metal particles was calculated using a sectional SEM image of a portion subject to measurement.

The definition of the average degree of orientation of the soft magnetic metal particles and a method of measuring the same are shown below.

Measurement of the average degree of orientation of the soft magnetic metal particles was carried out using a SEM image of a section parallel to the winding axis direction of the coil. An angle formed by the winding axis direction of the coil and a major axis of a soft magnetic metal particle i was defined as a deflection angle θi of the soft magnetic metal particle i with respect to the winding axis direction of the coil. Average cos 20 of the soft magnetic metal particles was calculated by μ cos 2θi/N (i=1, 2, . . . . N), where N was the number of the soft magnetic metal particles. The size of the SEM image of the section was determined so that N≥100 was satisfied. Σ cos 2θi/N was defined as the average degree of orientation of the soft magnetic metal particles.

Direct current resistance Rdc of the inductors of Sample Nos. 1 to 7 was measured. Rdc was measured using an impedance analyzer (IM3570 manufactured by HIOKI E.E. CORPORATION). Table 1 shows the results.

The inductance L0 of the inductors of Sample Nos. 1 to 7 before a direct current was applied was measured. L0 was measured using an RF impedance material analyzer (4491A manufactured by Agilent Technologies) at a measurement frequency of 1 MHz and a measurement voltage of 500 mV. Table 1 shows the results.

Isat of the inductors of Sample Nos. 1 to 7 was measured to evaluate their DC superimposition characteristics. Specifically, with a direct current starting from 0 being applied to each inductor, the direct current at which inductance was reduced to 0.70×L0 (inductance L0 at a direct current of 0) was defined as Isat (−30%). Table 1 shows the results. DC superimposition characteristics were defined as good when Isat (−30%) was 2.60 A or more.

The organic substance content of the first central portion 6a, the organic substance content of the second central portion 6b, and the organic substance content of the outer portion 6c of the inductors of Sample Nos. 1 to 7 were confirmed using a thermogravimetry-differential thermal analyzer (STA7200RV manufactured by Hitachi High-Tech Corporation). The temperature range of the thermogravimetry-differential thermal analysis (TG-DTA) was 30° C. to 850° C. The ambient gas was a nitrogen gas. Loss on ignition measured using the TG-DTA method was deemed to be the organic substance content. Conditions were substantially the same among the first central portion 6a, the second central portion 6b, and the outer portion 6c except for their organic substance content. Thus, it was assumed that the lower the organic substance content, the higher the permeability.

TABLE 1

| | | | First | | Organic matter | | | | | | |
|---|---|---|---|---|---|---|---|---|---|---|---|
| | | Winding | central | Central | content [wt %] | | | | Properties | | |
| | | portion | portion | portion | First | Second | | | | | Isat |
| Example/ | Sample | H | S₁ | S | central | central | Outer | | Rdc | L0 | (−30%) |
| Comparative example | No. | [mm] | [mm²] | [mm²] | portion | portion | portion | X | [mΩ] | [μH] | [A] |
| Comparative example | 1 | 4.16 | 4.52 | 6.16 | 1.5 | 3.3 | 3.3 | 1.27 | 346 | 100 | 2.50 |
| Comparative example | 2 | 4.16 | 3.14 | 6.16 | 1.5 | 2.8 | 2.8 | 1.06 | 346 | 101 | 2.51 |
| Example | 3 | 4.16 | 2.01 | 6.16 | 1.5 | 2.6 | 2.6 | 0.85 | 346 | 100 | 2.66 |
| Example | 4 | 4.16 | 1.13 | 6.16 | 1.5 | 2.4 | 2.4 | 0.64 | 346 | 100 | 2.60 |
| Comparative example | 5 | 4.16 | 0.50 | 6.16 | 1.5 | 2.3 | 2.3 | 0.42 | 346 | 100 | 2.50 |
| Comparative example | 6 | 4.16 | 0.13 | 6.16 | 1.5 | 2.2 | 2.2 | 0.21 | 346 | 101 | 2.50 |
| Comparative example | 7 | 4.16 | 0.00 | 6.16 | — | 2.2 | 2.2 | 0.00 | 346 | 100 | 2.50 |

According to Table 1, Examples in which X calculated using S, S₁, and H was within 0.50 or more and 0.90 or less had good DC superimposition characteristics. By contrast, Comparative examples in which X was out of the above range had DC superimposition characteristics inferior to those of Examples.

### Experiment 2

A method of manufacturing inductor samples of Example and Comparative example shown in Table 2 is described.

In Sample No. 9 (Example) and Sample No. 8 (Comparative example) of Experiment 2, the insert member 4a1 had dimensions different from those of Sample Nos. 1 to 7 of Experiment 1. The winding portion 4 of the insert member 4a1 had an outside diameter of 4.70 mm, an inside diameter of 2.90 mm, a wire diameter (diameter of the conductor 5) of 0.21 mm, a number of turns N of 55.5 ts., and a height H of 3.63 mm. Table 2 shows the results.

TABLE 2

| | | | First | | Organic matter | | | | | | |
|---|---|---|---|---|---|---|---|---|---|---|---|
| | | Winding | central | Central | content [wt %] | | | | Properties | | |
| Example/ | | portion | portion | portion | First | Second | | | | | Isat |
| Comparative | Sample | H | S₁ | S | central | central | Outer | | Rdc | L0 | (−30%) |
| example | No. | [mm] | [mm²] | [mm²] | portion | portion | portion | X | [mΩ] | [μH] | [A] |
| Comparative example | 8 | 3.63 | 6.16 | 6.61 | 1.5 | 3.3 | 3.3 | 1.21 | 348 | 101 | 2.42 |
| Example | 9 | 3.63 | 2.27 | 6.61 | 1.5 | 2.6 | 2.6 | 0.73 | 348 | 100 | 2.74 |

According to Table 2, Example in which X was within 0.50 or more and 0.90 or less had good DC superimposition characteristics. By contrast, Comparative example in which X was out of the above range had DC superimposition characteristics inferior to those of Example.

### Experiment 3

A method of manufacturing inductor samples of Examples and Comparative examples shown in Table 3 is described.

In Examples and Comparative examples of Experiment 3, the insert member 4a1 had dimensions different from those of Experiment 1. The winding portion 4 of the insert member 4a1 had an outside diameter of 4.70 mm, an inside diameter of 2.90 mm, a wire diameter (diameter of the conductor 5) of 0.21 mm, a number of turns N of 55.5 ts., and a height H of 3.63 mm.

Further, unlike Experiment 1, the first central core 6a1 was sintered. The firing temperature was 700° C. The firing time was 1 hour. The firing atmosphere was nitrogen. Table 3 shows the results.

In Examples of Experiment 3, the organic substance content of the first central portion 6a was lower than the organic substance content of the first central portion 6a of Examples of Experiments 1 and 2. Thus, it was assumed that permeability of the first central portion 6a was higher than permeability of the first central portion 6a of Examples of Experiments 1 and 2.

TABLE 3

| | | | First | | Organic matter | | | | | | |
|---|---|---|---|---|---|---|---|---|---|---|---|
| | | Winding | central | Central | content [wt %] | | | | Properties | | |
| Example/ | | portion | portion | portion | First | Second | | | | | Isat |
| Comparative | Sample | H | S₁ | S | central | central | Outer | | Rdc | L0 | (−30%) |
| example | No. | [mm] | [mm²] | [mm²] | portion | portion | portion | X | [mΩ] | [μH] | [A] |
| Comparative example | 10 | 3.63 | 3.46 | 6.61 | <0.1 | 3.1 | 3.1 | 0.91 | 348 | 100 | 2.45 |
| Example | 11 | 3.63 | 2.27 | 6.61 | <0.1 | 2.8 | 2.8 | 0.73 | 348 | 99 | 2.69 |
| Example | 12 | 3.63 | 1.33 | 6.61 | <0.1 | 2.6 | 2.6 | 0.56 | 348 | 99 | 2.83 |
| Comparative example | 13 | 3.63 | 0.64 | 6.61 | <0.1 | 2.3 | 2.3 | 0.39 | 348 | 101 | 2.53 |

According to Table 3, Examples in which X was within 0.50 or more and 0.90 or less had good DC superimposition characteristics. By contrast, Comparative examples in which X was out of the above range had DC superimposition characteristics inferior to those of Examples.

### Experiment 4

A method of manufacturing inductor samples of Examples shown in Table 4 is described.

In Examples of Experiment 4, the insert member 4a1 had dimensions different from those of Experiment 1. The winding portion 4 of the insert member 4a1 had an outside diameter of 4.90 mm, an inside diameter of 3.10 mm, a wire diameter (diameter of the conductor 5) of 0.21 mm, a number of turns N of 52.5 ts., and a height H of 3.50 mm. Also, similarly to Examples of Experiment 3, the first central core 6a1 of Sample Nos. 15 to 17 was sintered. Table 4 shows the results.

It was assumed that permeability of the first central portion 6a of Sample No. 14 of Experiment 4 was about the same as permeability of the first central portion 6a of Examples of Experiments 1 and 2. It was assumed that permeability of the first central portion 6a of Sample Nos. 15 to 17 of Experiment 4 was about the same as permeability of the first central portion 6a of Examples of Experiment 3.

TABLE 4

| | | | First | | Organic matter | | | | | | |
|---|---|---|---|---|---|---|---|---|---|---|---|
| | | Winding | central | Central | content [wt %] | | | | Properties | | |
| Example/ | | portion | portion | portion | First | Second | | | | | Isat |
| Comparative | Sample | H | S₁ | S | central | central | Outer | | Rdc | L0 | (−30%) |
| example | No. | [mm] | [mm²] | [mm²] | portion | portion | portion | X | [mΩ] | [μH] | [A] |
| Example | 14 | 3.50 | 3.46 | 7.55 | 1.5 | 2.4 | 2.4 | 0.76 | 344 | 100 | 2.79 |
| Example | 15 | 3.50 | 4.15 | 7.55 | <0.1 | 2.7 | 2.7 | 0.84 | 344 | 100 | 2.83 |
| Example | 16 | 3.50 | 3.46 | 7.55 | <0.1 | 2.6 | 2.6 | 0.76 | 344 | 100 | 2.90 |
| Example | 17 | 3.50 | 2.27 | 7.55 | <0.1 | 2.3 | 2.3 | 0.62 | 344 | 101 | 2.67 |

According to Table 4, Examples in which X was within 0.50 or more and 0.90 or less had good DC superimposition characteristics.

### Experiment 5

A method of manufacturing an inductor sample of Example (Sample No. 18) shown in Table 5 is described.

In Experiment 5, as shown in FIG. 5, the inductor sample was manufactured by integrating a first central core 6a1, a second central core 6b1, a base core 6c1, a cover core 6c2, and an insert member 4a1 including a winding portion 4 composed of an air core coil or the like. Differences between the inductor sample of Experiment 5 and the inductor sample of Sample No. 14 were substantially only the organic substance content of the second central portion and the organic substance content of the outer portion. Table 5 shows the results.

TABLE 5

| | | | First | | Organic matter | | | | | | |
|---|---|---|---|---|---|---|---|---|---|---|---|
| | | Winding | central | Central | content [wt %] | | | | Properties | | |
| Example/ | | portion | portion | portion | First | Second | | | | | Isat |
| Comparative | Sample | H | S₁ | S | central | central | Outer | | Rdc | L0 | (−30%) |
| example | No. | [mm] | [mm²] | [mm²] | portion | portion | portion | X | [mΩ] | [μH] | [A] |
| Example | 14 | 3.50 | 3.46 | 7.55 | 1.5 | 2.4 | 2.4 | 0.76 | 344 | 100 | 2.79 |
| Example | 18 | 3.50 | 3.46 | 7.55 | 1.5 | 2.2 | 2.6 | 0.76 | 344 | 100 | 2.82 |

According to Table 5, also in a situation where the first central portion, the second central portion, and the outer portion had different organic substance contents, Example in which X was within 0.50 or more and 0.90 or less had good DC superimposition characteristics.

### Experiment 6

A method of manufacturing inductor samples of Examples (Sample Nos. 19 to 21) shown in Table 6 is described.

In Experiment 6, dimensions of the insert member, S₁, and S were the same as those of Sample No. 14.

In Sample No. 14, the organic substance content of the first central portion was lower than the organic substance content of the second central portion and the organic substance content of the outer portion. By contrast, in Sample Nos. 19 to 21, the organic substance content of the first central portion was increased from that of Sample No. 14 so as to be the same as the organic substance content of the second central portion and the organic substance content of the outer portion.

In Sample No. 19, the average particle size of the soft magnetic metal powder used for preparation of the first central core was changed from about 25 μm to about 27 μm.

In Sample No. 20, the molding pressure of the first central core was changed so that the packing ratio of the soft magnetic metal particles of the first central portion was increased from 69% to 71%.

In Sample No. 21, the average degree of orientation of the soft magnetic metal particles of the first central portion was changed from 0.0 to 0.3. Specifically, instead of directly preparing the first central core having a cylindrical shape by pressure-molding, a sufficiently large core having a quadrangular prism shape was prepared by pressure-molding. At the time of preparing the core having the quadrangular prism shape, the direction in which pressure was applied was perpendicular to the winding axis direction of the coil of the coil component eventually obtained. Also, at the time of molding, the mold was appropriately heated. Then, the core having the quadrangular prism shape was subject to machining to prepare the first central core having a cylindrical shape.

TABLE 6

| | | | | | First | First | | | | | | |
|---|---|---|---|---|---|---|---|---|---|---|---|---|
| | | | | | central | central | First | First | | | | |
| | | | First | | portion | portion | central | central | | | | |
| | | Winding | central | Central | Organic | Average | portion | portion | | Properties | | |
| Example/ | | portion | portion | portion | matter | particle | Packing | Average | | | | Isat |
| Comparative | Sample | H | S₁ | S | content | size | ratio | degree of | | Rdc | L0 | (−30%) |
| example | No. | [mm] | [mm²] | [mm²] | [wt %] | [μm] | [%] | orientation | X | [mΩ] | [μH] | [A] |
| Example | 14 | 3.50 | 3.46 | 7.55 | 1.5 | 25 | 69 | 0.0 | 0.76 | 344 | 100 | 2.79 |
| Example | 19 | 3.50 | 3.46 | 7.55 | 2.4 | 27 | 69 | 0.0 | 0.76 | 344 | 100 | 2.68 |
| Example | 20 | 3.50 | 3.46 | 7.55 | 2.4 | 25 | 71 | 0.0 | 0.76 | 344 | 100 | 2.68 |
| Example | 21 | 3.50 | 3.46 | 7.55 | 2.4 | 25 | 69 | 0.3 | 0.76 | 344 | 100 | 2.74 |

According to Table 6, Examples in which X was within 0.50 or more and 0.90 or less had good DC superimposition characteristics despite other parameters of the first central portion, instead of its organic substance content, being changed. Sample No. 14, in which the organic substance content was 1.5 wt %, had higher Isat and better DC superimposition characteristics than Sample Nos. 19 to 21, in which the organic substance content was 2.4 wt %.

### [Additional Notes]

The technology of the present disclosure includes the following example configurations but may include any other configurations.

[1] A coil component including:
a core portion including a soft magnetic metal material; and
a winding portion including a conductor wound, in which
the winding portion is inside the core portion;
the core portion includes a central portion and an outer portion;
the central portion is disposed in an inside diameter portion of the winding portion;
the outer portion is disposed in a portion other than the central portion;
the central portion includes a first central portion and a second central portion including different materials;
the second central portion is disposed around the first central portion; and
X defined by a mathematical formula 1 satisfies 0.50 or more and 0.90 or less, the mathematical formula 1 being defined as follows:

$$X = \frac{\sqrt{π}}{2} \times \frac{H \times \sqrt{{S}_{1}}}{S}$$

where
H denotes a height of the winding portion in a section containing an axial centerline of the winding portion,
S denotes a sectional area of the central portion in a section perpendicular to the axial centerline of the winding portion, and
S₁ denotes a sectional area of the first central portion in the section perpendicular to the axial centerline of the winding portion.

[2] The coil component according to [1], in which the second central portion includes a material different from that of the outer portion.

[3] The coil component according to [1] or [2], in which the first central portion has a permeability higher than that of the second central portion.

[4] The coil component according to any one of [1] to [3], in which the first central portion has an organic compound content lower than that of the second central portion.

[5] The coil component according to any one of [1] to [4], in which at least a part of the core portion substantially does not include an organic compound.

[6] The coil component according to any one of [1] to [5], in which the first central portion has an organic compound content of 1.5 wt % or less.

[7] The coil component according to any one of [1] to [6], in which
the first central portion includes soft magnetic metal particles as the soft magnetic metal material;
the second central portion includes soft magnetic metal particles as the soft magnetic metal material; and
the soft magnetic metal particles included in the first central portion have an average particle size larger than that of the soft magnetic metal particles included in the second central portion.

[8] The coil component according to any one of [1] to [7], in which
the first central portion includes soft magnetic metal particles as the soft magnetic metal material;
the second central portion includes soft magnetic metal particles as the soft magnetic metal material; and
the soft magnetic metal particles included in the first central portion have a packing ratio higher than that of the soft magnetic metal particles included in the second central portion.

[9] The coil component according to any one of [1] to [8], in which
the first central portion includes soft magnetic metal particles as the soft magnetic metal material;
the second central portion includes soft magnetic metal particles as the soft magnetic metal material; and
the soft magnetic metal particles included in the first central portion have an average degree of orientation different from that of the soft magnetic metal particles included in the second central portion with respect to an axial direction of the winding portion.

A power supply apparatus including the coil component according to any one of [1] to [9].

### REFERENCE NUMERALS

2 . . . inductor
4 . . . winding portion
5 . . . conductor
6a . . . first central portion
6b . . . second central portion
6c . . . outer portion
4a1 . . . insert member
6a1 . . . first central core
6b1 . . . second central core
6c1 . . . base core
6c2 . . . cover core

What is claimed is:

1. A coil component comprising:
a core portion comprising a soft magnetic metal material; and
a winding portion comprising a conductor wound,
wherein
the winding portion is inside the core portion;
the core portion comprises a central portion and an outer portion;
the central portion is disposed in an inside diameter portion of the winding portion;
the outer portion is disposed in a portion other than the central portion;
the central portion comprises a first central portion and a second central portion comprising different materials;
the second central portion is disposed around the first central portion; and
X defined by a mathematical formula 1 satisfies 0.50 or more and 0.90 or less, the mathematical formula 1 being defined as follows:
$$X = \frac{\sqrt{π}}{2} \times \frac{H \times \sqrt{{S}_{1}}}{S}$$
where
H denotes a height of the winding portion in a section containing an axial centerline of the winding portion,
S denotes a sectional area of the central portion in a section perpendicular to the axial centerline of the winding portion, and
S₁ denotes a sectional area of the first central portion in the section perpendicular to the axial centerline of the winding portion.

2. The coil component according to claim 1, wherein the second central portion comprises a material different from that of the outer portion.

3. The coil component according to claim 1, wherein the first central portion has a permeability higher than that of the second central portion.

4. The coil component according to claim 1, wherein the first central portion has an organic compound content lower than that of the second central portion.

5. The coil component according to claim 1, wherein at least a part of the core portion substantially does not comprise an organic compound.

6. The coil component according to claim 1, wherein the first central portion has an organic compound content of 1.5 wt % or less.

7. The coil component according to claim 1, wherein
the first central portion comprises soft magnetic metal particles as the soft magnetic metal material;
the second central portion comprises soft magnetic metal particles as the soft magnetic metal material; and
the soft magnetic metal particles included in the first central portion have an average particle size larger than that of the soft magnetic metal particles included in the second central portion.

8. The coil component according to claim 1, wherein
the first central portion comprises soft magnetic metal particles as the soft magnetic metal material;
the second central portion comprises soft magnetic metal particles as the soft magnetic metal material; and
the soft magnetic metal particles included in the first central portion have a packing ratio higher than that of the soft magnetic metal particles included in the second central portion.

9. The coil component according to claim 1, wherein
the first central portion comprises soft magnetic metal particles as the soft magnetic metal material;
the second central portion comprises soft magnetic metal particles as the soft magnetic metal material; and
the soft magnetic metal particles included in the first central portion have an average degree of orientation different from that of the soft magnetic metal particles included in the second central portion with respect to an axial direction of the winding portion.

10. A power supply apparatus comprising the coil component according to claim 1.
